(19) United States
(12) Patent Application Publication
(10) Pub. No.: US 2022/0128935 A1
(43) Pub. Date: Apr. 28, 2022

(54) FIXING DEVICE AND IMAGE FORMING DEVICE

(71) Applicant: Konica Minolta, Inc., Tokyo (JP)

(72) Inventor: Masashi NAKABO, Toyokawa-shi Aichi (JP)

(21) Appl. No.: 17/472,535

(22) Filed: Sep. 10, 2021

(30) Foreign Application Priority Data
Oct. 22, 2020 (JP) 2020-177254

(51) Int. Cl. G03G 15/20

(52) U.S. Cl. CPC G03G 15/2028

(57) ABSTRACT

A fixing device that fixes a toner image by passing a sheet through a fixing nip, including a pressure body and a rotating body pressed together to form the fixing nip and a separator disposed above the rotating body in the vertical direction. The separator separates the sheet from the rotating body downstream of the fixing nip. The separator includes a separation portion that has a first outer surface facing the rotating body and a second outer surface facing a sheet transport path after separation and a support portion that supports the separation portion. The separation portion has a higher releasability than the support portion. The first outer surface and the second outer surface intersect at an acute angle to form a sharp edge portion. The first outer surface has a convex portion at a position between the sharp edge portion and a boundary with the support portion.

The entire disclosure of Japanese Patent Application No. 2020-177254, filed on Oct. 22, 2020, is incorporated herein by reference in its entirety.

### BACKGROUND

### (1) Technical Field

The present disclosure relates to fixing devices, and in particular to techniques for preventing poor fixing and image deterioration caused by debris particles adhering to a separators and accumulating into lumps, where the separators separate sheets from a rotating body when the sheets are discharged from a fixing nip.

### (2) Description of the Related Art

An electrophotographic image forming device includes a fixing device for heat-fixing a toner image on a sheet. The fixing device forms a fixing nip by pressure contact between a fixing member such as a fixing roller or fixing belt and a pressure member such as a pressure roller or pressure pad. When a sheet passes through the fixing nip, a toner image carried on the sheet is meted by the high-temperature fixing member and pressed onto the sheet.

Subsequently, when the sheet is supposed to separate from the fixing nip, if the sheet wraps around a rotating body such as the fixing member or the pressure member, a jam occurs. Therefore, separators are installed for separating the sheet from a rotating body. For example, as illustrated in FIG. 9A, a separator 9 has been proposed that is composed of a base member (support portion) 902 made of a hard material and having a wedge-shaped tip and a fluororesin layer (separation portion) 901 that covers a face of the base member 902 that faces a sheet discharge path (see JP 2011-164389 A).

The fluororesin layer 901 has high releasability, and therefore a sheet discharged from the fixing nip can be smoothly separated from the fixing member and the pressure member. Further, the separator 9 being composed of two parts, the support portion 902 and the separation portion 901, means that costs can be reduced and strength can be improved.

Further, as illustrated in FIG. 9B, if a coating layer 903 made of fluororesin is provided on a surface 904 of the base member 902 facing a fixing belt (not illustrated), opposite the face on which the fluororesin layer 901 is provided, then it is possible to prevent wear and scuffing of the fixing belt due to the tip of the separator 9 coming into sliding contact with the fixing belt.

When a sheet is separated from a rotating body such as a fixing member or pressure roller, the separator scrapes debris particles such as paper dust and toner from the surface of the sheet where the wedge-shaped tip comes into contact with the sheet. The scraped off debris particles may be dispersed by air flow generated by rotation of a rotating body or transport of a sheet, and may adhere to an outer surface of the separation portion 901 facing a rotating body.

When debris particles adhering to the separation portion 901 further move onto the support portion 902, the support portion 902 does not have a high releasability, so the debris particles may stay on the support portion 902, accumulate, and grow into a lump. When a lump of debris particles grows to a certain size, it may fall onto the fixing member or pressure roller, causing an image defect or jam. In particular, such problems are more likely to occur towards the end of the life of the device.

### SUMMARY

The present disclosure is made in view of the technical problems described above, and an object of the present disclosure is to provide a fixing device and an image forming device capably of suppressing image defects and jams caused by debris particles dropped from a separator.

In order to achieve at least the above object, a fixing device reflecting an aspect of the present invention is a fixing device that fixes a toner image by passing a sheet through a fixing nip, the fixing device comprising: a pressure body and a rotating body pressed together to form the fixing nip; and a separator disposed above the rotating body in a vertical direction when in use, the separator separating the sheet from the rotating body downstream of the fixing nip in the direction of rotation of the rotating body. The separator comprises: a separation portion that has a first outer surface facing the rotating body and a second outer surface facing a sheet transport path after separation; and a support portion that supports the separation portion. The separation portion has a higher releasability than the support portion, the first outer surface and the second outer surface intersect at an acute angle to form a sharp edge portion, and the first outer surface has a convex portion at a position between the sharp edge portion and a boundary with the support portion, along the direction of rotation of the rotating body.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the invention.

FIG. 1 illustrates main elements of an image forming device 1 pertaining to an embodiment.

FIG. 2 illustrates main elements of a fixing device 100 pertaining to an embodiment.

FIG. 3 illustrates an arrangement of separators 200 in the fixing device 100.

FIG. 4A illustrates front, side, and rear views of a separator 200. FIG. 4B includes a perspective view illustrating a step formed by a separation portion 201 and a support portion 202 of the separator 200, and an enlargement 412 of an area of the perspective view indicated as a dashed line area 411. FIG. 4C includes another perspective view illustrating the step formed by the separation portion 201 and the support portion 202 of the separator 200, and an enlargement 422 of an area of the perspective view indicated as a dashed line area 421.

FIG. 5 illustrates a mechanism by which a debris particle 501 falls from an outer surface 403 of the separation portion 201, due to the protrusion 401.

FIG. 6A illustrates relative positions of the support portion 202 and a pressure roller 211. FIG. 6B illustrates how the separator 200 scrapes debris particles from a sheet S.

FIG. 7A, 7B, 7C, 7D illustrate shapes of protrusions 703, 711, and 731 pertaining to modifications of the present disclosure.

FIG. 8 illustrates main elements of the fixing device 100 pertaining to a modification of the present disclosure.

FIGS. 9A and 9B each illustrate main elements of separators according to prior art.

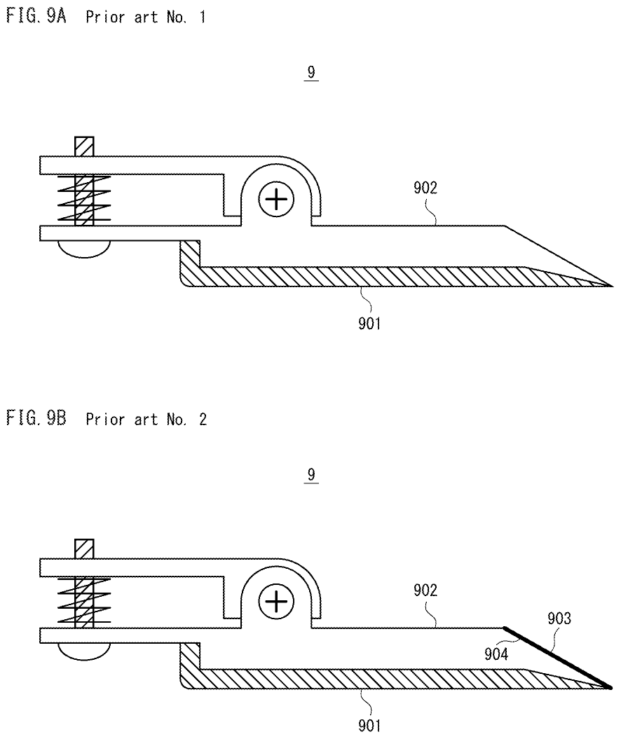

FIG. 10A is a front view diagram illustrating how debris particles 1001 adhering to a tip 404 of the separator 200 moves from an outer surface 402 to a side surface due to friction against sheets. FIG. 10B is a perspective view diagram illustrating how debris particles 1001 fall from the step after movement along the side surface.

### DETAILED DESCRIPTION OF EMBODIMENTS

The following describes embodiments of a fixing device and image forming device pertaining to the present disclosure, with reference to the drawings.

### [1] Structure of Image Forming Device 1

First, structure of an image forming device pertaining to an embodiment is described below.

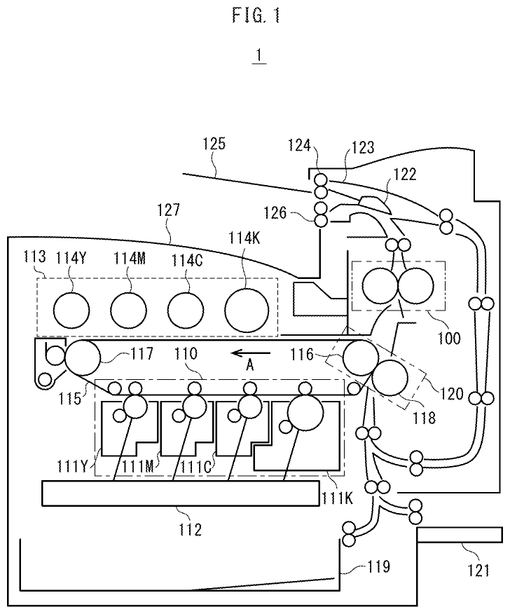

As illustrated in FIG. 1, the image forming device 1 is a tandem-type color printer, and includes a fixing section (also referred to as a fixing device) 100, an imaging section 110, and a secondary transfer section 120. The imaging section 110 includes imaging units 111Y, 111M, 111C, and 111K that form yellow (Y), magenta (M), cyan (C), and black (K) color toner images, respectively.

The imaging units 111Y, 111M, 111C, and 111K each include a photosensitive drum, a charging device, a developer device, a primary transfer roller, and a cleaning device. The charging device uniformly charges an outer circumferential surface of the photosensitive drum. An exposure device 112 forms electrostatic latent images by irradiating the outer circumferential surfaces of the photosensitive drums with laser beams modulated according to an image to be formed.

A developer supply section 113 includes toner bottles 114Y, 114M, 114C, and 114K containing Y, M, C, and K toner, respectively, which are detachably mounted and supply toner to the corresponding developer devices. The developer devices develop the electrostatic latent images by supplying toner to the outer circumferential surfaces of the photosensitive drums. The primary transfer rollers electrostatically transfer toner images from the outer circumferential surfaces of the photosensitive drums to an outer circumferential surface of an intermediate transfer belt 115.

In this primary transfer, a color toner image is formed by transfer of toner images of each color to overlay each other on the outer circumferential surface of the intermediate transfer belt 115. When forming a monochrome toner image, only one color of toner image is transferred onto the outer circumferential surface of the intermediate transfer belt 115.

The intermediate transfer belt 115 is an endless belt, kept taut by a driving roller 116, a driven roller 117, and primary transfer rollers, and travels in the direction of an arrow A in FIG. 1. The driving roller 116 and a secondary transfer roller 118 form the secondary transfer section 120. The driving roller 116 and the secondary transfer roller 118 form a secondary transfer nip, pressing against each other with the intermediate transfer belt 115 sandwiched between them. The intermediate transfer belt 115 travels in the direction of the arrow A to transport the toner image carried on the outer circumferential surface of the intermediate transfer belt 115 to the secondary transfer nip.

A sheet feed tray 119 accommodates a stack of sheets. Further, a sheet stack may be placed on a manual feed tray 121. A sheet is transported from the sheet feed tray 119 or the manual feed tray 121 (according to user instruction) to the secondary transfer nip at the same timing as a toner image is transported to the secondary transfer nip. A transfer bias is applied to the secondary transfer roller 118, electrostatically transferring the toner image from the outer circumferential surface of the intermediate transfer belt 115 to the sheet (secondary transfer).

The sheet with the toner image is transported to the fixing section 100, where the toner image is heat-fixed. A switcher 122 switches a transport direction of the sheet on which the toner image is heat-fixed. When an image is also to be formed on a back side of the sheet, the switcher 122 guides the sheet to the duplex reverse path 123. A reverse roller 124 reverses the transport direction of the sheet guided by the duplex reverse path 123.

At this time, a portion of the sheet is sent out temporarily onto a switchback tray 125 then pulled back into the image forming device 1. The sheet is again transported to the secondary transfer nip, a toner image is transferred to the back surface, and the toner image is heat-fixed. In single-sided printing or when image forming is completed on both sides, the switcher 122 guides the sheet to the sheet ejection roller 126. The sheet ejection roller 126 ejects the sheet onto an ejected sheet tray 127.

### [2] Structure of Fixing Device 100

The following describes structure of the fixing device 100.

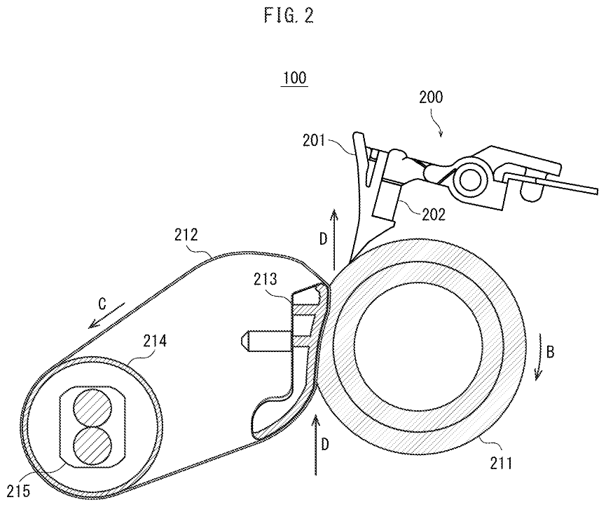

As illustrated in FIG. 2, the fixing device 100 includes a pressure roller 211, a fixing belt 212, and a fixing pad 213. The pressure roller 211 presses against the fixing pad 213 with the fixing belt 212 sandwiched between them, thereby forming a fixing nip. The fixing belt 212 is hung around the fixing pad 213 and a heating roller 214, and is driven by the pressure roller 211 rotating in a direction indicated by an arrow A to travel in a direction indicated by an arrow C. In this way, a sheet is transported in a direction indicated by an arrow D.

The heating roller 214 has a heater 215 such as a halogen lamp built-in, and is heated when the heater 215 is turned on. When the temperature of the heating roller 214 rises due to this heating, the fixing belt 212 is heated by the heating roller 214 and the temperature rise. The pressure roller 211 pressing the sheet against the heated fixing belt 212 causes toner carried on the sheet to be melted and heat-fixed to the sheet.

The separators 200 are fixed on a sheet discharge side of the fixing nip, with wedge-shaped tips of the separators 200 either in non-contact positions with a very small gap between them and the outer circumferential surface of the pressure roller 211 or in contact with the outer circumferential surface of the pressure roller 211. The separators 200 separate sheets from the outer circumferential surface of the pressure roller 211 so that the sheets do not wrap around the pressure roller 211. The separators 200 each include a separation portion 201 disposed facing the sheet discharge path and a support portion 202 for fixing the separator 200 in a position as described above.

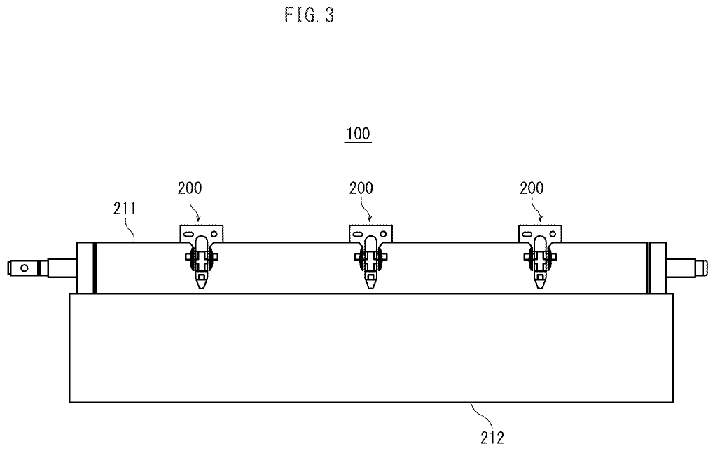

As illustrated in FIG. 3, three separators 200 are arranged along an axial direction of the pressure roller 211. The number of the separators 200 is not limited to three, and may be a number other three. Generally speaking, when a sheet is strong such as a sheet of thick paper, it is unlikely to wrap around the pressure roller 211, and when a sheet is weak such as a sheet of thin paper, it is more likely to wrap around the pressure roller 211. Further, as the ease of wrapping also varies depending on sheet size, the number of the separators should be designed based on a case where sheets are most likely to wrap around the pressure roller 211.

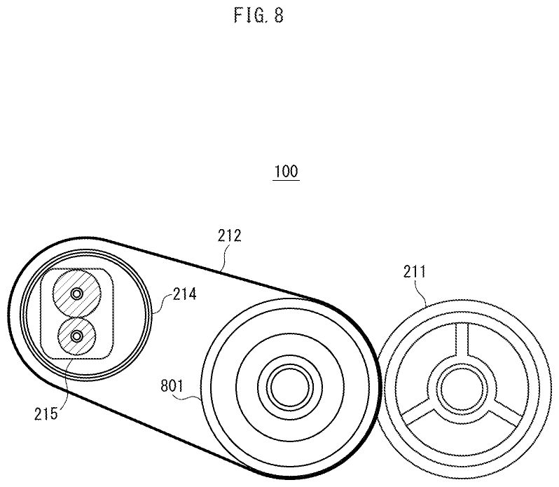

Further, structure of the fixing device 100 is not limited to that described above. As illustrated in FIG. 8, a roller member may be used instead of the fixing pad 213, or a pressure roller may be directly pressed against a fixing roller. Alternatively, a pressure pad may be directly pressed against a fixing roller. As long as the structure forms a fixing nip where a pressure member is pressed against a fixing rotating body, the fixing rotating body may be a fixing belt or fixing roller, and the pressure member may be a pressure roller or pressure pad.

### [3] Structure of Separators 200

The following describes structure of each of the separators 200 in terms of one example separator 200.

As described above, the separator 200 includes the separation portion 201 and the support portion 202. Further, the separator 200 is disposed near an outlet of the fixing nip and continuously exposed to high temperature during image forming, and therefore use of a resin material having high heat resistance is necessary. The separation portion 201 preferably has high releasability in order to prevent toner from a sheet from adhering to the separation portion 201 when the sheet is released from the fixing nip at a high temperature and rubs against the separation portion 201.

Therefore, according to at least one embodiment, a fluororesin is used as a material of the separation portion 201. As the fluororesin, tetrafluoroethylene-perfluoroalkyl vinyl ether copolymer (PFA) has a particularly high releasability, and is therefore beneficial in countering deposition and adhesion of toner and paper dust. Aside from PFA, examples of fluororesins that may be used include tetrafluoroethylene hexafluoropropylene copolymer (FEP) resin, ethylene tetrafluoroethylene (ETFE) resin, polyvinylidene fluoride (PVDF) resin, polyvinyl fluoride (PVF) resin, ethylene chlorotrifluoroethylene (ECTFE) resin, and the like.

An example of PFA and FEP is Teflon (registered trademark) of DuPont-Mitsui Co., Ltd. An example of FEP and ETFE is Aflon (registered trademark) of Asahi Glass Co., Ltd. An example of COP and PVDF is Kynar (registered trademark) of Arkema Japan Co., Ltd. An example of ECTFE is Hylar (registered trademark) of Solvay Co., Ltd.

Further, if a filler that has low friction with the pressure roller 211 such as aramid fiber, talc, mica, or graphite is added to the fluororesin, this can reduce wear on the pressure roller 211 due to contact and friction with the separation portion 201. Further, as a material of the separation portion 201, a material other than fluororesin such as silicone resin may be used.

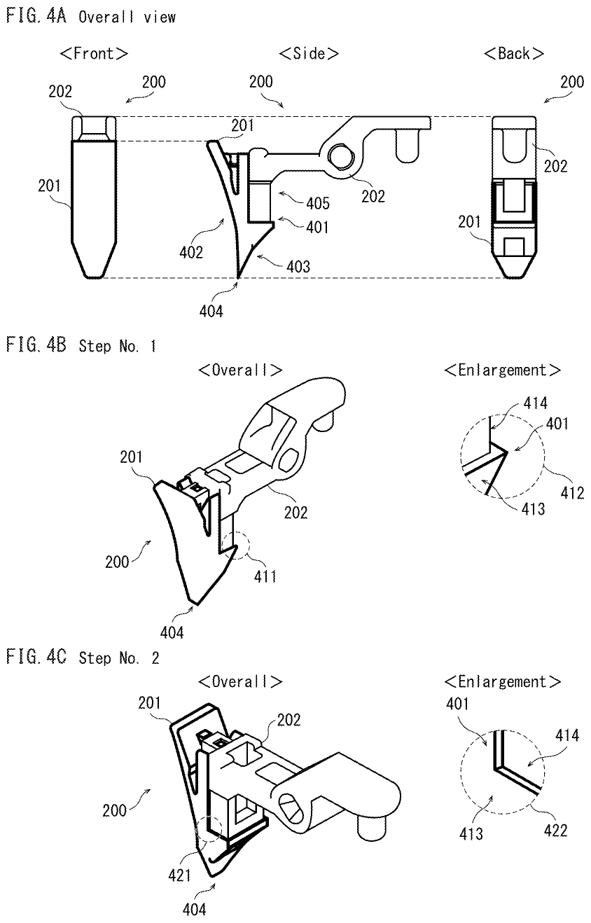

As illustrated in FIG. 4A, the separation unit 201 has an outer surface 402 that is removed from the fixing nip and faces the transport path of a sheet separated from the pressure roller 211 and an outer surface 403 facing the pressure roller 211, and these outer surfaces continue as outer surfaces of a wedge shape that projects towards the fixing nip. The outer surfaces of the wedge shape include a portion that has a constant width in the axial direction of the pressure roller 211 and a tip 404 projecting towards the fixing nip that has an acute angle in a cross section orthogonal to the axial direction (see “side view” in FIG. 4A). The tip 404 has a sharply-pointed shape.

Widths of the outer surfaces 402, 403 of the separation portion 201 in the axial direction of the pressure roller 211 gradually decrease approaching the pressure roller 211. The outer surface 402 has a function of guiding transport of a sheet separated from the pressure roller 211. The shape described above means that the separation portion 201 has a reduced area that can come into contact with the pressure roller 211, such that it is difficult for toner and paper dust to adhere to the separation portion 201 and accumulate on the support portion 202.

The support portion 202 is narrower than the separation portion 201 in the axial direction of the pressure roller 211, and is snap-fastened by press-fitting into the separation portion 201. In this way, the snap-fastening fixes the separation portion 201 so as to cover the support portion 202.

For the support portion 202, a resin material may be used such as polyether ether ketone (PEEK), polyether ketone (PEK), liquid crystal polymer (LCP), or polyphenylsulfide (PPS), or a metal material may be used such as aluminum. These materials have heat resistance and sufficient rigidity (mechanical strength).

An outer surface 405 of the support portion 202 facing the pressure roller 211 is further away from the pressure roller 211 than the outer surface 403 of the separation portion 201 facing the pressure roller 211, forming a “step”. The outer surface 403 of the separation portion 201 has a higher releasability than the outer surface 405 of the support portion 202, such that even if paper dust or toner (also referred to as “debris particles”) on the outer surface 403 of the separation portion 201 moves downstream following the direction of rotation of the pressure roller 211, the debris particles cannot go around the step to reach the outer surface 405 of the support portion 202, and do not necessarily adhere to the outer surface 405 of the support portion 202. Therefore, accumulation of debris particles into a lump on the outer surface 405 of the support portion 202 can be suppressed.

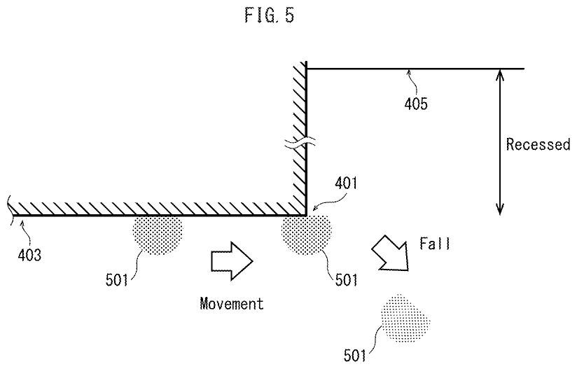

Further a corner 401 of the step is a protrusion in the sense that it is not flat. In this sense, it can be said that the corner 401 is a protrusion 401 of the outer surface 403 of the separation portion 201 between the tip 404 and a boundary with the support portion 202 along the rotation direction of the pressure roller 211. As illustrated in FIG. 5, when an air flow is generated around the separator 200 or the separator 200 vibrates due to rotation of the pressure roller 211 or transport of a sheet, debris particles adhering to the outer surface 403 of the separation portion 201 may move along the outer surface 403. When a debris particle 501 reaches the convex portion 401 due to this movement, the convex shape of the outer surface 401 reduces a contact area between the debris particle 501 and the outer surface 403.

The outer surface 403 of the separation portion 201 has a high releasability, making it difficult for the debris particle 501 to adhere, and therefore debris particles do not accumulate and grow into a lump. Accordingly, when the contact area between the debris particle 501 and the outer surface 403 is small, the debris particle 501 easily separates from the outer surface 403. Therefore, when the contact area between the debris particle 501 and the outer surface 403 is reduced, the debris particle 501 cannot maintain a contact state with the outer surface 403 and falls off.

As described above, the outer surface 405 of the support portion 202 is recessed from the outer surface 403 of the separation portion 201, and therefore the debris particle 501 that falls off does not adhere to the outer surface 405 of the support portion 202, instead moving to the outer circumferential surface of the pressure roller 211 or another place. The debris particle 501 is small and has not grown into a lump, and therefore even if it falls on the outer circumferential surface of the pressure roller 211, there is no risk of causing wear of the pressure roller 211, poor fixing, image deterioration, or jams.

Accordingly, the amount of the debris particles 501 that move to the outer surface 405 of the support portion 202 can be reduced, and therefore it is possible to prevent debris particles growing into a lump on the outer surface 405 of the support portion 202, falling to the outer circumferential surface of the pressure roller 211 due to air flow, vibration of the separator 200, or under its own weight, and causing wear of the pressure roller 211, poor fixing, or image deterioration.

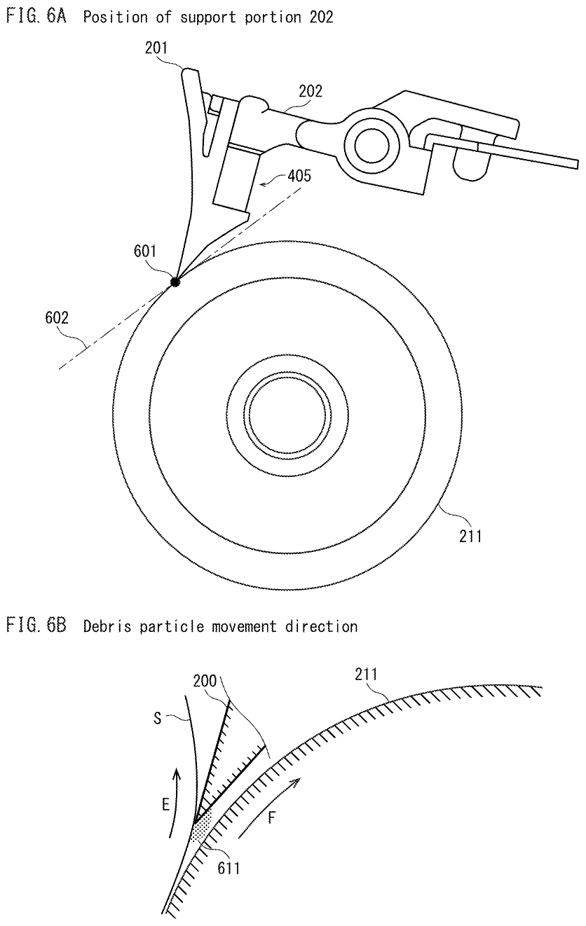

As illustrated in FIG. 6A, the outer surface 403 of the separation portion 201 and the outer surface 405 of the support portion 202 forming the step are disposed farther from the pressure roller 211 than a tangent plane 602 to the circumferential surface of the pressure roller 211 when the point of tangency is a closest point to the tip of the separator 200. As illustrated in FIG. 6B, a debris particle 611 scraped off by the separator 200 from a sheet S being transported in the direction indicated by an arrow E nibs against the outer circumferential surface of the pressure roller 211 rotating in the direction indicated by an arrow F, at a position on the outer circumferential surface of the pressure roller 211 closest to the tip of the separator 200.

Due to this rubbing, the debris particle 611 receives a friction force along the tangent plane at this position and is scattered. Therefore, as long as the support portion 202 is arranged at a position removed from the tangent plane 602, a travel direction of the debris particle 611 will miss the outer surface 405 of the support portion 202, and therefore the debris particle 611 is unlikely to adhere to the outer surface 405.

Aside from the outer surface facing the pressure roller 211, steps are also formed as illustrated in FIGS. 4B and 4C, in an outer surface 413 of the separation portion 201 relative to an outer surface 414 of the support portion 202, the outer surface 413 corresponding to a side surface between an outer surface facing the pressure roller 211 and an outer surface facing a sheet transport path. When a debris particle scraped off by the separator 200 is pressed against the tip of the separator 200 by rotation of the pressure roller 211, the debris particle can be affected by a force that also moves it in the axial direction of the pressure roller 211.

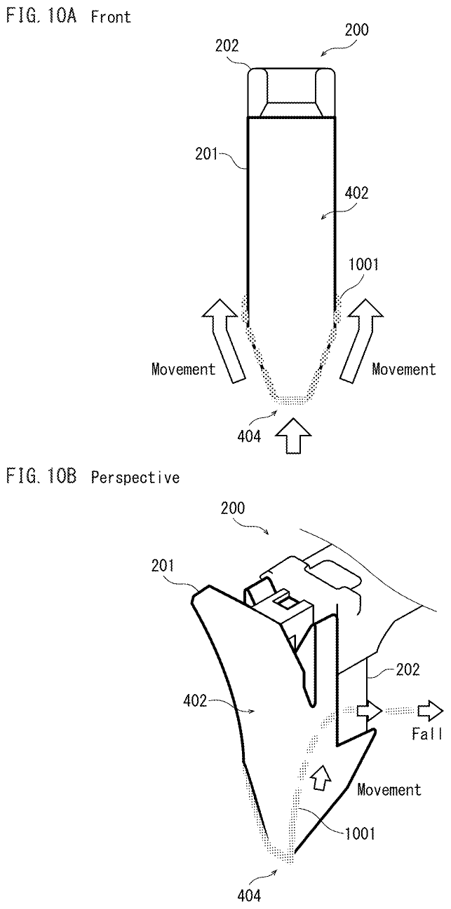

When such a force acts on a debris particle, then as illustrated in FIGS. 10A and 10B, debris particles 1001 scraped from a sheet by the separator 200 can also move to side surfaces of the separator 200. Thus, in the side surfaces, the outer surface 414 of the support portion 202 is recessed from the outer surface 413 of the separation portion 201, forming a step between the outer surface 413 of the separation portion 201 and the outer surface 414 of the support portion 202, and therefore as illustrated in FIG. 10B, the debris particles 1001 can be made to fall off at the step.

Accordingly, it is possible to prevent debris particles from adhering to and accumulating on the outer surface 414 of the support portion 202, and therefore it is possible to prevent the problems mentioned above, caused by debris particles growing into a lump on the outer surface 414 of the support portion 202 and falling onto the outer circumferential surface of the pressure roller 211.

Further, a step can be similarly provided on a side surface opposite the side surface 413 illustrated. Structure of the separation portion 201 is not limited to having steps on the outer surface 403 and both side surface 413 of the separation portion 201. According to at least one embodiment, a step may be provided on one of either the outer surface 403 or the side surfaces 413 of the separation portion 201. Even with a structure in which a step is not provided in one or the other of the outer surface 403 and the side surfaces 413 of the separation portion 201, an effect is achieved of reducing adherence of debris particles to the outer surface 405 or the side surface 414 of the support portion 202.

### [4] Modifications

Although the present disclosure has been described based on at least one embodiment, the present disclosure is of course not limited to any embodiment described. The following modifications can be implemented.

(4-1) According to at least one embodiment, an example is described in which a step is formed between an outer surface of the separation portion 201 and an outer surface of the support portion 202, to prevent accumulation of debris particles, but the present disclosure is not limited to this example, and the following alternatives may be used.

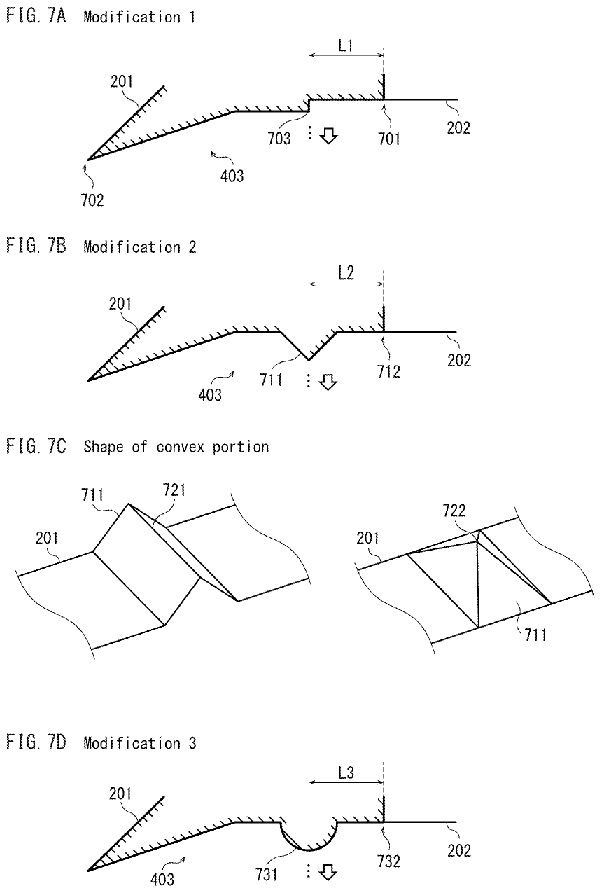

For example, as illustrated in FIG. 7A, a convex portion 703 may be provided at a position closer to a tip 702 of the separator 200 than a boundary 701 between the separation portion 201 and the support portion 202. According to this structure, debris particles that adhere to the separation portion 201 and are moved towards the support portion 202 fall from the separator 200 upon reaching the convex portion 703, and therefore debris particles adhering to the support portion 202 and growing into lumps can be prevented.

Note that of the outer surface 403 of the separation portion 201 facing the pressure roller 211, debris particles attached to the portion from the convex portion 703 to the boundary 701 are not prevented by the convex portion 703 from moving from the separation portion 201 to the support portion 202. In this sense, a distance L1 from the convex portion 703 to the boundary 701 is preferably short.

Further, as illustrated in FIG. 7B, a convex portion 711 may be provided on the outer surface 403 of the separation portion 201 facing the pressure roller 211. The convex portion 711 has a shape that protrudes towards the pressure roller 211. Specifically, as illustrated in FIG. 7C, the convex portion 711 has a triangular prism shape having a ridge line 721 along the axial direction of the pressure roller 211. This structure means that debris particles can be caused to fall from the ridge line 721. Further, the convex portion 711 may have a quadrangular pyramid shape having an apex 722. This structure means that debris particles can be caused to fall from any of the four ridge lines extending from the apex 722.

Further, the convex portion need not have a ridge line and may be, for example, semicylindrical as illustrated in FIG. 7D. Even if semicircular in cross section, as in a convex portion 731, then when size and shape of a debris particle is unchanged, an arc-shaped curved surface has a smaller contact area with the debris particle than a flat surface, and therefore the effect of causing debris particles to fall from the outer surface 403 of the separation portion 201 is obtained.

Three-dimensional shapes that have a semicircular cross section include semicylindrical shapes and hemispherical shapes, but any shape that has a curved outer surface suffices. The larger the curvature, the greater the effect causing debris particles to fall off.

In both FIGS. 7B and 7D, of the outer surface 403 of the separation portion 201, debris particles attached to a portion from the convex portion 711, 731 to the boundary 712, 732 are not caused to fall by the convex portion 711, 731. Therefore, as per the distance L1 of FIG. 7A, a distance L2, L3 from the boundary 712, 732 between the separation portion 201 and the support portion 202 to the convex portion 711, 731 is preferably short.

(4-2) According to at least one embodiment, the separation portion 201 is described as having the outer surface 402 facing the sheet transport path after separation, the outer surface 403 facing the pressure roller 211, and the side surfaces 413 provided at ends of the separation portion 201 in the axial direction of the pressure roller 211, but the present disclosure is of course not limited to this structure. The following modifications may be used.

For example, the separation portion 201 need not have the outer surface 403 facing the pressure roller 211, and may have only the outer surface 402 facing the sheet transport path and the side surfaces 413. It may be the case that debris particles scraped from a sheet S by the separator 200 are mainly scattered towards the side surfaces 413, and a distance between the tip 404 and the pressure roller 211 is small, and therefore debris particles are less likely to scatter towards a surface of the separator 200 facing the pressure roller 211.

In this case, there is little problem in practical use even if the outer surface 403 facing the pressure roller 411 is not provided, and it is effective to provide convex portions to the side surfaces 413, preventing movement of debris particles from the side surfaces 413 to the support portion 202.

Alternatively, it may be the case that there is a larger gap between the tip 404 and the pressure roller 211, and due to rotation of the pressure roller 211, a large number of debris particles are scattered towards the outer surface 403 facing the pressure roller 211, while a smaller number of debris particles are scattered towards the side surfaces 413. In this case, if the side surfaces 413 are not provided, the outer surfaces 402, 403 are provided, and a convex portion is provided on the outer surface 403, then it is possible to prevent debris particles from accumulating on the support portion 202.

(4-3) According to at least one embodiment, the separation portion 201 is a member formed separately from the support portion 202, but the present disclosure is of course not limited to this example. The separation portion 201 may be a coating layer (separation layer) applied to a surface of the support portion 202.

(4-4) According to at least one embodiment, the image forming device 1 is described as a tandem-type color printer, but the present disclosure is of course not limited to this example. A color printer other than a tandem-type may be used. A monochrome printer may be used. Further, a copy device may be provided with a scanner, or may be a facsimile machine having a facsimile communication function.

Further, even if the image forming device 1 is a multi-function peripheral (MFP) that has such functions, the effects of the present disclosure can be obtained.

Although embodiments of the present invention have been described and illustrated in detail, the disclosed embodiments are made for purposes of illustration and example only and not limitation. The scope of the present invention should be interpreted by terms of the appended claims.

What is claimed is:

1. A fixing device that fixes a toner image by passing a sheet through a fixing nip, the fixing device comprising:
a pressure body and a rotating body pressed together to form the fixing nip; and
a separator disposed above the rotating body in a vertical direction when in use, the separator separating the sheet from the rotating body downstream of the fixing nip in the direction of rotation of the rotating body, wherein
the separator comprises:
a separation portion that has a first outer surface facing the rotating body and a second outer surface facing a sheet transport path after separation; and
a support portion that supports the separation portion, wherein
the separation portion has a higher releasability than the support portion,
the first outer surface and the second outer surface intersect at an acute angle to form a sharp edge portion, and
the first outer surface has a convex portion at a position between the sharp edge portion and a boundary with the support portion, along the direction of rotation of the rotating body.

2. A fixing device that fixes a toner image by passing a sheet through a fixing nip, the fixing device comprising:
a pressure body and a rotating body pressed together to form the fixing nip; and
a separator disposed above the rotating body in a vertical direction when in use, the separator separating the sheet from the rotating body downstream of the fixing nip in the direction of rotation of the rotating body, wherein
the separator comprises:
a separation portion that has side surfaces at either end in the axial direction of the rotating body and an outer surface facing a sheet transport path after separation; and
a support portion that supports the separation portion, wherein
the separation portion has a higher releasability than the support portion, and
each of the side surfaces have a convex portion at a position between an end of the side surface upstream in the rotation direction of the rotating body and a boundary with the support portion, along the direction of rotation of the rotating body.

3. The fixing device of claim 1, wherein
the convex portion is a step formed on the first outer surface, forming a boundary between the separation portion and the support portion, such that the support portion is farther than the separation portion from the rotating body at the step.

4. The fixing device of claim 3, wherein
the step is shaped such that, in the axial direction of the rotating body, width of the support portion is less than that of the separation portion at the step.

5. The fixing device of claim 3, wherein
an outer surface of the support portion extending from the boundary with the separation portion is farther from the rotating body than a tangent plane to an outer circumferential surface of the rotating body when the point of tangency is a closest point to a tip of the sharp edge portion.

6. The fixing device of claim 1, wherein
the support portion is press-fitted into and fixed to the separation portion such that the separation portion covers part of the support portion.

7. The fixing device of claim 1, wherein
the separation portion is a release layer formed on a surface of the support portion.

8. The fixing device of claim 1, wherein
The separation portion is composed of a fluororesin selected from tetrafluoroethylene-perfluoroalkyl vinyl ether copolymer (PFA), tetrafluoroethylene hexafluoropropylene copolymer (FEP) resin, ethylene tetrafluoroethylene (ETFE) resin, polyvinylidene fluoride (PVDF) resin, polyvinyl fluoride (PVF) resin, and ethylene chlorotrifluoroethylene (ECTFE) resin.

9. The fixing device of claim 1, wherein
The support portion is composed of a resin selected from polyether ether ketone (PEEK), polyether ketone (PEK), liquid crystal polymer (LCP), and polyphenyl sulfide (PPS).

10. The fixing device of claim 1, wherein
the sharp edge portion has a constant width in the axial direction of the rotating body, and has a tip that has an acute-angled cross section perpendicular to the axial direction.

11. The fixing device of claim 1, wherein
width of the sharp edge portion in the axial direction of the rotating body gradually decreases as the sharp edge portion approaches the rotating body.

12. The fixing device of claim 1, wherein
the separator is disposed so the sharp edge portion is not in contact with the rotating body.

13. The fixing device of claim 1, wherein
a plurality of the separator are arranged along the axial direction of the rotating body.

14. An image forming device comprising:
an imaging device that forms a toner image;
a transfer device that transfers the toner image to a sheet; and
a fixing device that fixes the toner image by passing the sheet through a fixing nip, the fixing device comprising:
a pressure body and a rotating body pressed together to form the fixing nip; and
a separator disposed above the rotating body in a vertical direction when in use, the separator separating the sheet from the rotating body downstream of the fixing nip in the direction of rotation of the rotating body, wherein
the separator comprises:
a separation portion that has a first outer surface facing the rotating body and a second outer surface facing a sheet transport path after separation; and
a support portion that supports the separation portion, wherein
the separation portion has a higher releasability than the support portion,
the first outer surface and the second outer surface intersect at an acute angle to form a sharp edge portion, and
the first outer surface has a convex portion at a position between the sharp edge portion and a boundary with the support portion, along the direction of rotation of the rotating body.

15. An image forming device comprising:
an imaging device that forms a toner image;
a transfer device that transfers the toner image to a sheet; and
a fixing device that fixes the toner image by passing the sheet through a fixing nip, the fixing device comprising:
a pressure body and a rotating body pressed together to form the fixing nip; and
a separator disposed above the rotating body in a vertical direction when in use, the separator separating the sheet from the rotating body downstream of the fixing nip in the direction of rotation of the rotating body, wherein
the separator comprises:
a separation portion that has side surfaces at either end in the axial direction of the rotating body and an outer surface facing a sheet transport path after separation; and
a support portion that supports the separation portion, wherein
the separation portion has a higher releasability than the support portion, and
each of the side surfaces have a convex portion at a position between an end of the side surface upstream in the rotation direction of the rotating body and a boundary with the support portion, along the direction of rotation of the rotating body.
